(19) United States
(12) Patent Application Publication
(10) Pub. No.: US 2026/0094086 A1
(43) Pub. Date: Apr. 2, 2026

(54) INFORMATION OUTPUT APPARATUS, INFORMATION OUTPUT METHOD, AND NON-TRANSITORY STORAGE MEDIUM

(71) Applicant: NEC Corporation, Tokyo (JP)

(72) Inventors: Takashi NONAKA, Tokyo (JP); Taiga Takahashi, Tokyo (JP); Mamoru Hirota, Tokyo (JP); Kentaro Nishida, Tokyo (JP)

(73) Assignee: NEC Corporation, Tokyo (JP)

(21) Appl. No.: 19/332,257

(22) Filed: Sep. 18, 2025

(30) Foreign Application Priority Data
Sep. 27, 2024 (JP) 2024-168960

(51) Int. Cl. G06Q 10/0631

(52) U.S. Cl. CPC G06Q 10/063119; G06Q 10/063112

(57) ABSTRACT

An information output device includes a first acquisition unit, a second acquisition unit, and an output unit. The first acquisition unit acquires supply information. The supply information is information capable of specifying the number of maintenance workers who perform maintenance on a target device for each of plural areas and for each of plural skills owned by the maintenance workers. The second acquisition unit acquires demand information. The demand information is information capable of specifying the required number of maintenance workers having the skill for each of the plural areas and each of the plural skills. The output unit outputs supply and demand information based on the supply information and the demand information in a specifiable mode for each of the plural areas.

This application is based upon and claims the benefit of priority from Japanese patent application No. 2024-168960, filed on September 27, 2024, the disclosure of which is incorporated herein in its entirety by reference.

### TECHNICAL FIELD

The present invention relates to an information output device, an information output method, and a program.

### BACKGROUND ART

In recent years, workers are often required to have various skills. JP 2014-178449 A discloses a device for supporting education of workers. The device acquires ability information regarding abilities of one or more workers, acquires work history information regarding work histories of one or more workers, and further acquires work request history information regarding work requests from one or more customers. Then, the device determines the education priority of education contents for each worker based on the ability information, the work history information, and the work request history information.

### SUMMARY

A maintenance worker who performs maintenance on a device is often assigned to a specific area. On the other hand, maintenance contents required for the device, for example, a cause of failure and a method of coping with the failure differ depending on the area. For this reason, it has been difficult to grasp whether there are sufficient maintenance workers having appropriate skills.

An information output device according to one aspect of the present disclosure includes first acquisition means for acquiring supply information capable of specifying the number of maintenance workers who perform maintenance on a target device for each of a plurality of areas and for each of a plurality of skills owned by the maintenance workers, second acquisition means for acquiring demand information capable of specifying the required number of maintenance workers having the skill for each of the plurality of areas and for each of the plurality of skills, and output means for outputting supply and demand information based on the supply information and the demand information in a specifiable mode for each of the plurality of areas.

An information output method according to one aspect of the present disclosure causes a computer to perform acquiring supply information capable of specifying the number of maintenance workers who perform maintenance on a target device for each of a plurality of areas and for each of a plurality of skills owned by the maintenance workers, acquiring demand information capable of specifying the required number of maintenance workers having the skill for each of the plurality of areas and for each of the plurality of skills, and outputting supply and demand information based on the supply information and the demand information in a specifiable mode for each of the plurality of areas.

A program according to one aspect of the present disclosure causes a computer to execute first acquisition means for acquiring supply information capable of specifying the number of maintenance workers who perform maintenance on a target device for each of a plurality of areas and for each of a plurality of skills owned by the maintenance workers, second acquisition means for acquiring demand information capable of specifying the required number of maintenance workers having the skill for each of the plurality of areas and for each of the plurality of skills, and output means for outputting supply and demand information based on the supply information and the demand information in a specifiable mode for each of the plurality of areas.

According to an example of the present disclosure, it is easy for a user of the examples to grasp whether there are sufficient maintenance workers having appropriate skills.

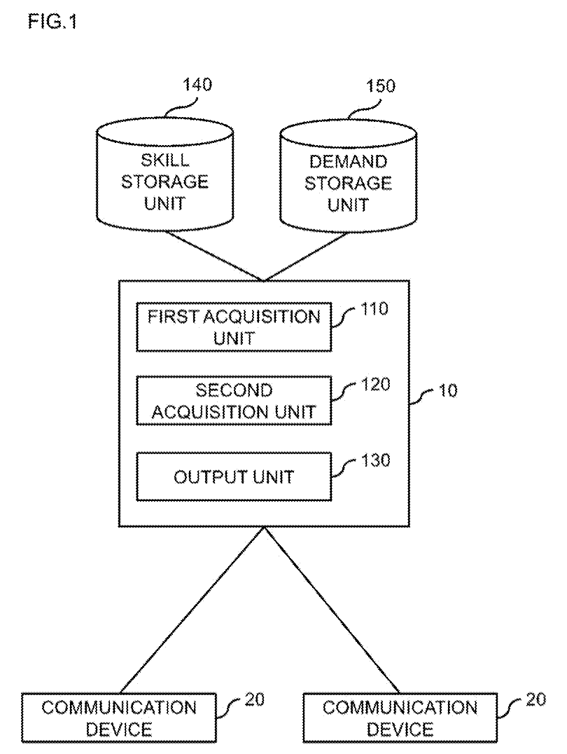

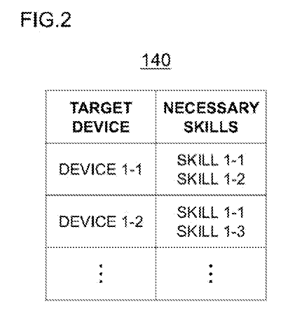

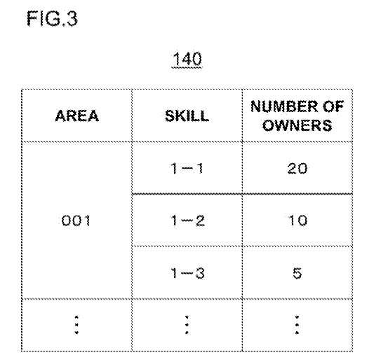

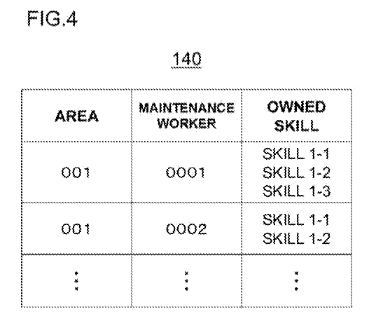

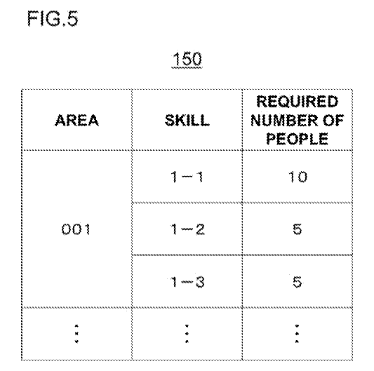

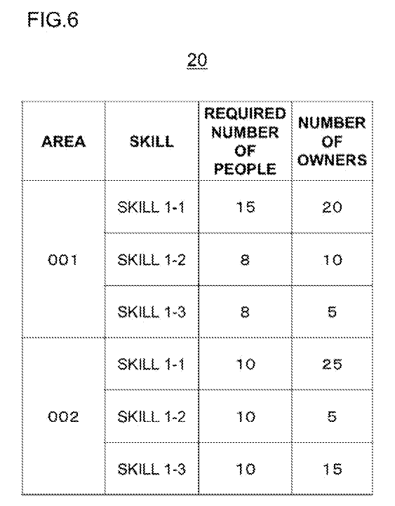

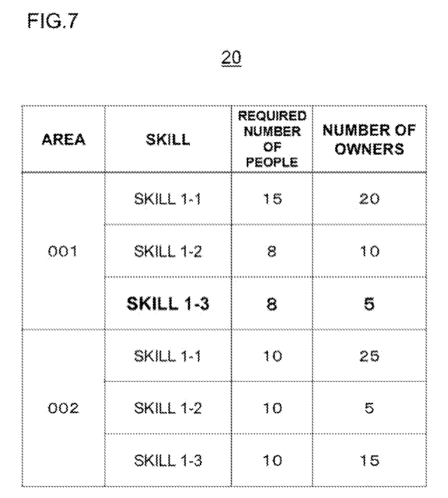

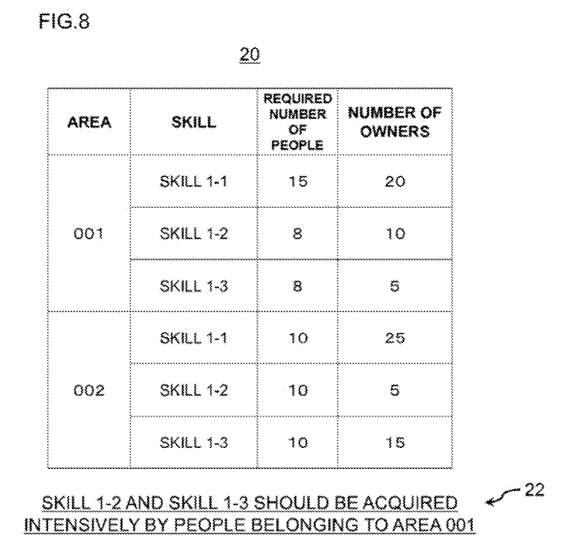

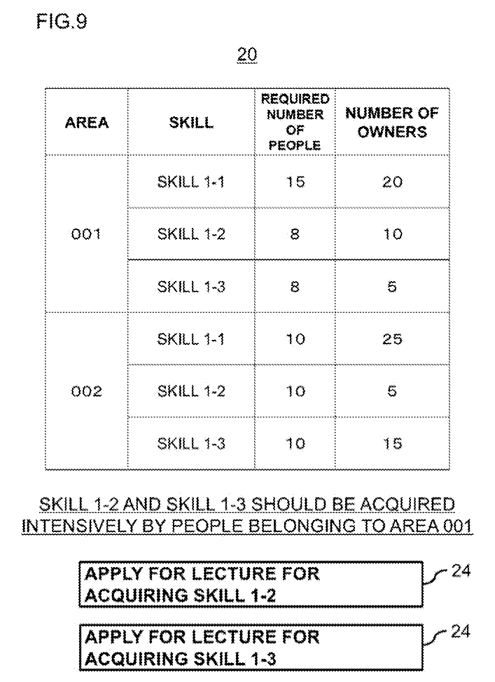

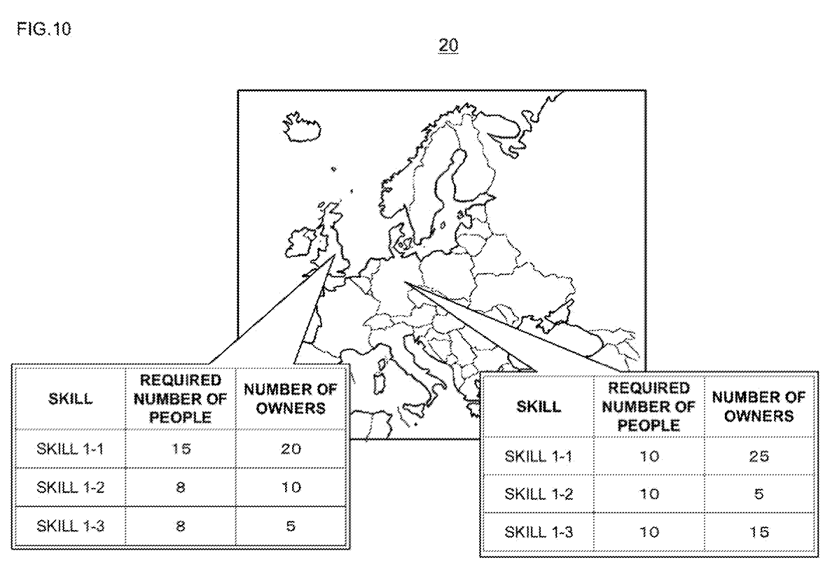

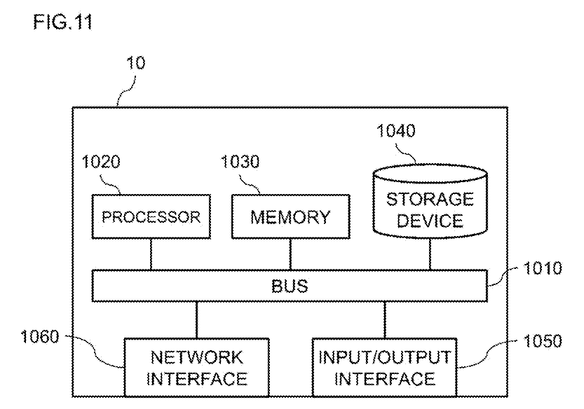

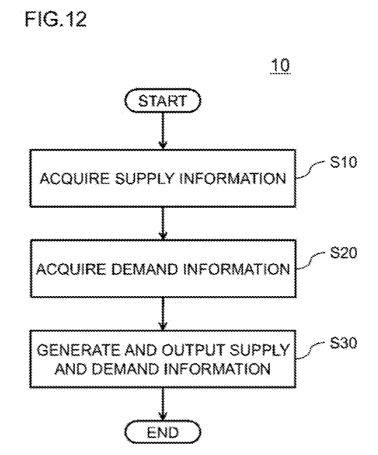

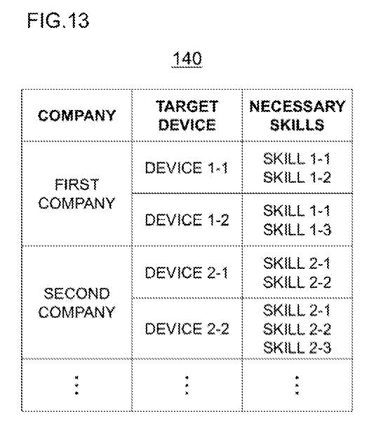

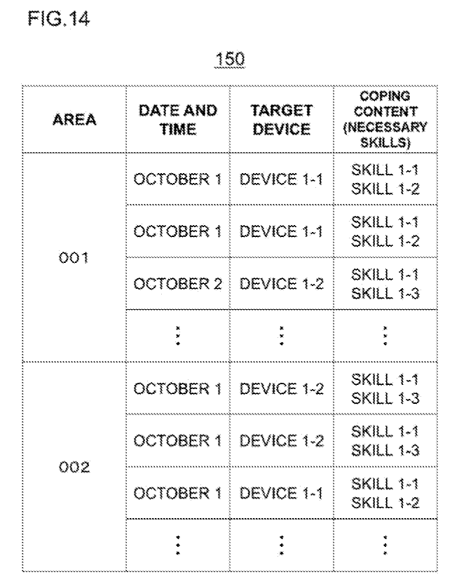

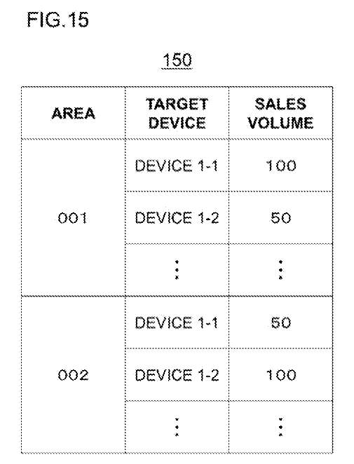

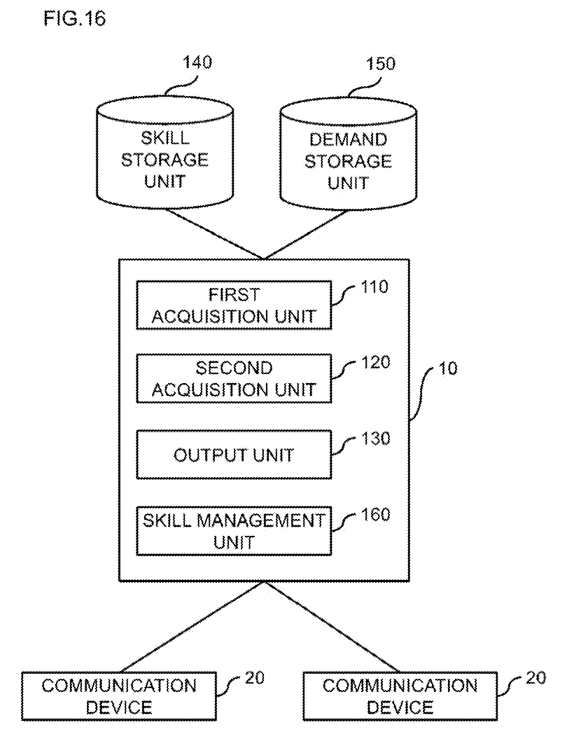

### BRIEF DESCRIPTION OF THE DRAWINGS

[FIG. 1] It is a block diagram illustrating an example of a configuration of an information output device according to the present disclosure together with a usage environment of the information output device;

[FIG. 2] It is a diagram illustrating an example of information stored in a skill storage unit;

[FIG. 3] It is a diagram illustrating an example of information stored in the skill storage unit;

[FIG. 4] It is a diagram illustrating an example of information stored in the skill storage unit;

[FIG. 5] It is a diagram illustrating an example of information stored in a demand storage unit;

[FIG. 6] It is a diagram illustrating information output by a communication device;

[FIG. 7] It is a diagram illustrating information output by the communication device;

[FIG. 8] It is a diagram illustrating information output by the communication device;

[FIG. 9] It is a diagram illustrating information output by the communication device;

[FIG. 10] It is a diagram illustrating information output by the communication device;

[FIG. 11] It is a diagram illustrating an example of a hardware configuration of the information output device;

[FIG. 12] It is a flowchart illustrating an example of processing performed by the information output device;

[FIG. 13] It is a diagram illustrating an example of information stored in the skill storage unit;

[FIG. 14] It is a diagram illustrating an example of information stored in the demand storage unit;

[FIG. 15] It is a diagram illustrating an example of information stored in the demand storage unit; and

[FIG. 16] It is a block diagram illustrating an example of a configuration of the information output device together with the usage environment of the information output device.

### EXAMPLE EMBODIMENT

Hereinafter, in the present disclosure, the drawings are associated with one or more example embodiments. In all the drawings, similar components are denoted by similar reference signs, and descriptions thereof will be omitted as appropriate.

An information output device 10 is a device for managing a skills owned by a maintenance workers who performs maintenance on a device, and is used together with communication devices 20, for example, as illustrated in FIG. 1. The communication device 20 may be operated by, for example, a maintenance worker or may be operated by an administrator who manages the maintenance worker. The communication device 20 may be a fixed communication device, a tablet communication device, or a portable communication device such as a so-called smartphone.

A target device is, for example, at least one of the following devices.

Electric device. An example of the electric device is at least one of an air conditioner having a temperature control function, a refrigerator, a washing machine, an information processing device such as a personal computer, and a printer.

Automobile. An automobile includes at least one of a vehicle driven by an internal combustion engine, an electric vehicle, a hybrid vehicle, and a fuel cell vehicle.

Gas appliance. An example of a gas appliance is at least one of a water heater and a gas stove.

Water supply equipment used in buildings. For example, the water supply equipment is at least one of a water supply distribution system and a sewerage drainage system.

A maintenance worker is often responsible for multiple types of devices. Even for the same type of device, the maintenance content may vary depending on an area where the device is used. Although a plurality of maintenance workers may be assigned to the same area, skills owned by the plurality of maintenance workers may also be different from each other. Therefore, the information output device 10 outputs information capable of specifying the number of maintenance workers who perform maintenance on the target device for each of a plurality of areas and for each of a plurality of skills owned by the maintenance workers, and outputs information capable of specifying the required number of maintenance workers having the skill for each of the plurality of areas and for each of the skills to the communication devices 20, for example. Therefore, the user of the communication device 20 can easily grasp whether there are sufficient maintenance workers having appropriate skills for each area. In a case where the person who operates the communication device 20 is a maintenance worker, the maintenance worker can easily grasp a skill that is better to be acquired by the maintenance worker.

Here, the skill is, for example, at least one of the following.

An ability to maintain a target device. This skill is set for each target device, for example. In a case where a plurality of types is assumed as maintenance, for example, in a case where there is a plurality of causes and/or symptoms of failure, skills may be set for each of the plurality of causes and/or symptoms.

The areas may be set, for example, in units of countries, in units of areas in one country, or in units of local governments.

The information output device 10 can use, for example, a skill storage unit 140 and a demand storage unit 150. The skill storage unit 140 and the demand storage unit 150 may be a part of the information output device 10 or may be located outside the information output device 10.

The skill storage unit 140 stores information regarding the skill owned by the maintenance worker. The information stored in the skill storage unit 140 includes at least one of supply information to be described later and information for generating the supply information. The skill storage unit 140 stores, for example, the following information.

Information capable of specifying a skill necessary for maintenance of a target device for each target device.

Information capable of specifying, for each maintenance worker, an area which the maintenance worker is in charge of and a skill owned by the maintenance worker.

A specific example of the information stored in the skill storage unit 140 will be described later.

The demand storage unit 150 stores information necessary for specifying the required number of maintenance workers having the skill for each skill for each of a plurality of areas. The information stored in the demand storage unit 150 includes at least one of demand information to be described later and information for generating the demand information. The demand storage unit 150 stores, for example, at least one of the following types of information.

Information indicating the required number of maintenance workers having the skill for each skill for each of a plurality of areas

Information capable of specifying result information indicating performance of maintenance performed on a target device for each target device and for each area

Sales information, for example, information capable of specifying a sales volume for each target device and for each of a plurality of areas

A specific example of the information stored in the demand storage unit 150 will be described later.

The information output device 10 includes a first acquisition unit 110, a second acquisition unit 120, and an output unit 130.

The first acquisition unit 110 acquires information capable of specifying the number of maintenance workers who perform maintenance on the target device for each of a plurality of areas and for each of a plurality of skills owned by the maintenance workers. Hereinafter, this information is referred to as supply information. For example, the first acquisition unit 110 acquires the supply information from the skill storage unit 140. The first acquisition unit 110 may acquire the supply information by generating the supply information using the information acquired from the skill storage unit 140.

The second acquisition unit 120 acquires, for each of a plurality of areas and for each of a plurality of skills, information capable of specifying the required number of maintenance workers having the skill. Hereinafter, this information is referred to as demand information. The second acquisition unit 120 acquires demand information from, for example, the demand storage unit 150. The second acquisition unit 120 may acquire the demand information by generating the demand information using the information acquired from the demand storage unit 150.

The output unit 130 outputs supply and demand information based on the supply information and the demand information in a specifiable mode for each of the plurality of areas. The output unit 130 outputs the supply and demand information to, for example, the communication device 20. The supply and demand information includes, for example, information for causing the user of the communication device 20 to recognize the supply information and the demand information in the area, and is generated by the output unit 130. In a case where the supply information includes text and numbers and the demand information includes text and numbers, the supply and demand information may directly include text and numbers as the supply information and text and numbers as the demand information, or may include a display screen in which these texts and numbers are fitted in a predetermined screen form. Examples of the text and the number here are a name of the skill and the number of owners of the skill.

Then, the communication device 20 outputs, for example, transmits the supply and demand information. An example of this output is to display on a display.

The user of the communication device 20 may input information into the communication device 20 to designate an area to which the supply and demand information is to be output. Hereinafter, this information is referred to as area designation information. In this case, the communication device 20 transmits the area designation information to the information output device 10. Then, the first acquisition unit 110 acquires supply information associated with the area designation information, and the second acquisition unit 120 acquires demand information associated with the area designation information. Then, the output unit 130 generates supply and demand information associated with the area designation information and outputs the supply and demand information to the communication device 20.

Next, a detailed example of the information stored in the skill storage unit 140 will be described.

For example, as illustrated in FIG. 2, the skill storage unit 140 stores, for each target device, information capable of specifying a skill necessary for maintenance of the target device. In the example illustrated in the drawing, the skill storage unit 140 stores identification information on the target device and identification information on the skill in association with each other. There may be one skill or a plurality of skills associated with one target device. For example, in a case where one target device has a plurality of maintenance targets (for example, parts or a combination of a plurality of parts) and skills necessary for maintenance are different for each of the plurality of maintenance targets, the skill storage unit 140 stores the plurality of skills in association with one target device. In a case where a certain maintenance target is commonly used by a plurality of target devices, the skill storage unit 140 stores the same skill in association with a plurality of different target devices.

The skill storage unit 140 may store the information described with reference to FIG. 2 for each of a plurality of areas. This is because, even in the same target product, maintenance contents such as a factor of failure may vary depending on the area.

As illustrated in FIG. 3, the skill storage unit 140 may store, for each of a plurality of areas, the number of maintenance workers owning the skill for each of a plurality of skills. However, the skill storage unit 140 may store information for generating the information instead of the information itself illustrated in FIG. 3.

For example, as illustrated in FIG. 4, the skill storage unit 140 may store, for each of a plurality of maintenance workers, an area to which the maintenance worker belongs and a skill owned by the maintenance worker in association with each other.

Next, a detailed example of the information stored in the demand storage unit 150 will be described with reference to FIG. 5. The demand storage unit 150 stores, for example, information indicating the required number of maintenance workers having the skill for each of a plurality of areas and for each skill. Although the demand storage unit 150 may store other information, these examples will be described later.

Next, a detailed example of the supply and demand information output by the communication device 20 will be described. The output performed here is a display on the display. This display may be a part of the communication device 20 or may be located outside the communication device 20. An example described below can also be regarded as an example of the supply and demand information output by the output unit 130.

For example, as illustrated in FIG. 6, the supply and demand information includes information indicating the required number of maintenance workers having the skill and the current number of owners for each of a plurality of areas and for each skill. The example of this information is a table, but may be indicated in a format other than a table. In FIG. 5, the required number of maintenance workers and the current number of owners are displayed in association with each other (for example, in line). As a result, the user of the communication device 20 can grasp whether there are sufficient maintenance workers having appropriate skills for each area.

In the example illustrated in FIG. 6, a skill for which the required number of people is larger than the number of owners may be displayed in a mode different from other skills as illustrated in FIG. 7. An example of the different aspect here is at least one of bolding the characters, increasing the size of the characters, changing the font, and changing the color of the characters, but is not limited thereto. In this way, the user of the communication device 20 can easily grasp the skill in which the maintenance worker is insufficient for each area.

As illustrated in FIG. 8, the communication device 20 may output the recommended skill information 22 in addition to the information illustrated in FIG. 6 or 7. The recommended skill information 22 is information indicating a skill to be acquired by a maintenance worker belonging to each of a plurality of areas, and is generated by the output unit 130 using the supply information and the demand information. For example, the output unit 130 specifies a skill for which the required number of people is larger than the number of owners, and generates information indicating the skill as recommended skill information. The recommended skill information 22 includes, for example, text. Here, the output unit 130 may set only the skill in which a difference between the required number of people and the number of owners, that is, the insufficient number of people satisfies a criterion as the target of the recommended skill information. The criterion used here may be indicated by an absolute value of the insufficient number of people, or may be indicated by a ratio of the insufficient number of people to at least one of the required number of people and the number of owners. Then, the output unit 130 targets a skill of which the number of insufficient people or the ratio is equal to or more than a reference value, as the recommended skill information. In a case where the target device includes a second target device to be described later, the skill indicated by the recommended skill information 22 may include a skill for supporting the second target device.

As illustrated in FIG. 9, the communication device 20 may output support information 24 in addition to the information illustrated in FIG. 8. The support information 24 is information capable of specifying a method for acquiring the skill indicated by the recommended skill information, and includes, for example, at least one of a button for displaying information indicating a method for acquiring the skill and a button for applying for a lecture for acquiring the skill. However, the support information 24 may include other information. This example is applied, for example, in a case where the user of the communication device 20 is a maintenance worker. Therefore, according to this example, the maintenance worker can easily acquire the skill.

As illustrated in FIG. 10, the communication device 20 may display a map on the display, and may display the supply and demand information for each of a plurality of areas in association with a region associated with the area in the map. The supply and demand information may be displayed, for example, in a blow-out format, may be displayed in such a way as to be superimposed on an area associated with the supply and demand information in a map, or may be displayed in another format. In this way, for example, a person who manages the maintenance worker can easily grasp which skill is insufficient in which area.

If the user of the communication device 20 selects a specific area on the map, for example, by moving a cursor, the supply and demand information associated with the area may be displayed to be superimposed on the area, or may be displayed in a pop-up format associated with the area.

In the example illustrated in FIG. 10, the output unit 130 outputs map information for causing the display to display the map, and generates information for causing the display to display the supply and demand information for each of a plurality of areas in association with a region associated with the area in the map, and outputs the generated information to the communication device 20.

As illustrated in FIG. 11, for example, the information output device 10 includes a bus 1010, a processor 1020, a memory 1030, a storage device 1040, an input/output interface 1050, and a network interface 1060 as a hardware configuration.

The bus 1010 is a data transmission path for the processor 1020, the memory 1030, the storage device 1040, the input/output interface 1050, and the network interface 1060 to transmit and receive data to and from each other. However, the method for connecting the processor 1020 and the like to each other is not limited to the bus connection.

The processor 1020 is a processor implemented by a central processing unit (CPU), a graphics processing unit (GPU), or the like.

The memory 1030 is a main storage device implemented by a random access memory (RAM) or the like.

The storage device 1040 is an auxiliary storage device implemented by a removable medium such as a hard disk drive (HDD), a solid state drive (SSD), and a memory card, or a read only memory (ROM), and has a recording medium. A recording medium of the storage device 1040 stores a program module that achieves each function (for example, the first acquisition unit 110, the second acquisition unit 120, the output unit 130, and a skill management unit 160 to be described later) of the information output device 10. The processor 1020 implements the functions associated with the program modules by reading and executing the program modules on the memory 1030. The storage device 1040 may further function as at least one of the skill storage unit 140 and the demand storage unit 150.

The input/output interface 1050 is an interface for connecting the information output device 10 and various input/output devices. For example, the information output device 10 may communicate with at least one of the skill storage unit 140 and the demand storage unit 150 via the input/output interface 1050.

The network interface 1060 is an interface for connecting the information output device 10 to a network. The network is, for example, a local area network (LAN) or a wide area network (WAN). A method for connecting the network interface 1060 to the network may be a wireless connection or a wired connection. The information output device 10 may communicate with at least one of the communication device 20, the skill storage unit 140, and the demand storage unit 150 via the network interface 1060.

The information output device 10 operates as illustrated in FIG. 12, for example. First, the user of the communication device 20 inputs information indicating that the supply and demand information is requested to the communication device 20. Then, the communication device 20 transmits information indicating this request to the information output device 10.

Then, the first acquisition unit 110 of the information output device 10 acquires the supply information (step S10). The second acquisition unit 120 of the information output device 10 acquires demand information (step S20). Next, the output unit 130 of the information output device 10 generates supply and demand information and outputs the supply and demand information to the communication device 20 (step S30).

Then, upon acquiring the supply and demand information, the communication device 20 displays the information on, for example, a display.

As described above, the supply and demand information is information based on the supply information and the demand information, and includes, for example, information for causing the user of the communication device 20 to recognize the supply information and the demand information in the area. Therefore, using the information output device 10, the user of the communication device 20 can grasp whether there are sufficient maintenance workers having appropriate skills for each area. In a case where the person who operates the communication device 20 is a maintenance worker, the maintenance worker can easily grasp a skill that is better to be acquired by the maintenance worker.

Typically, there are a plurality of types of target devices. At least two or more of the plurality of maintenance workers targeted by the information output device 10 often belong to at least one of the first company and an associated company of the first company. The associated company includes, for example, at least one of a company having a capital relationship with the first company and a company having a business cooperation with the first company. Hereinafter, the maintenance worker belonging to the first company or the associated company is referred to as a first maintenance worker.

The first maintenance worker may maintain only a device that is produced and/or sold by the first company, that is, the first target device, or may also maintain, in addition to the first target device, a device that is produced and/or sold by a second company different from both the first company and its associated company, that is, the second target device. In the latter case, the plurality of skills that can be owned by the first maintenance worker includes the first skill set for the first target device and the second skill set for the second target device.

Then, the skill storage unit 140 further stores data illustrated in FIG. 13, that is, information capable of specifying, for each of a plurality of companies, a target device manufactured and/or sold by the company and information capable of specifying a skill necessary for maintenance of the target device in association with each other. An example of these pieces of information is a combination of the identification information of the target device and the identification information of the skill.

In this way, the number of types of target devices that can be handled by one maintenance worker increases.

At least one of the skills necessary for the second target device may be any of the first skills. In other words, the same maintenance skill may be required for the target devices manufactured by different companies.

The demand storage unit 150 may further store data illustrated in FIG. 14, that is, performance information indicating performance of maintenance performed on the target device. The performance information stores, for example, for each area, a date and time at which maintenance has been performed, information that can specify a target device subjected to maintenance, and information that can specify a skill required for maintenance. The “information that can specify a skill required for maintenance” is, for example, identification information of the skill. However, in a case where the cause or symptom of the failure and the skill necessary for coping with the cause or symptom are stored in advance in association with each other, for example, in the skill storage unit 140, the “information that can specify the skill necessary for maintenance” may be the cause or symptom of the failure.

In this case, the second acquisition unit 120 may generate the demand information using the performance information. For example, the second acquisition unit 120 may aggregate the number of times the skill was required for each skill during a period from the present time to a first period ago, convert the aggregated value into a value in units of a second period (however, shorter than the first period), and use the converted value as the demand information. Here, the first period may be, for example, one month, two months or more, or one year. The second period may be, for example, one week, or may be any value of one day or more and six days or less.

The demand storage unit 150 may further store data illustrated in FIG. 15, that is, sales information for each of a plurality of types of target devices and for each of a plurality of areas. The sales information is, for example, the cumulative sales volume of the target devices, but may be a sales volume for a predetermined period, for example, every year.

In this case, the second acquisition unit 120 may generate demand information by using the sales information for each of the plurality of types of target devices and each of the plurality of areas. For example, the second acquisition unit 120 multiplies the value indicated by the sales information by a coefficient less than 1 preset for each type of maintenance, thereby calculating an estimated value of the number of times of maintenance occurrence for each type of maintenance. Then, the second acquisition unit 120 calculates the demand information by aggregating the estimated value for each skill necessary for maintenance. The “coefficient less than 1” is, for example, a value obtained by statistically calculating the occurrence probability of maintenance. Here, the “coefficient less than 1” may be set for each elapsed time from sale.

As illustrated in FIG. 16, the information output device 10 may include the skill management unit 160 in addition to the above-described configuration. The skill management unit 160 causes the skill storage unit 140 to store, for each of a plurality of maintenance workers, owned skill information indicating a skill owned by the maintenance worker according to Verifiable Credentials. In this way, for example, even if the company to which the maintenance worker belongs changes, it continues to be proved that the maintenance worker has the skill.

The skill management unit 160 may perform processing for providing an incentive associated with the skill owned by the maintenance worker. The incentive may be provision of at least one of money, an article, and a service, or may be giving an award.

The incentive may be given to a maintenance worker, or may be given to a department in charge of maintenance of a target device in an organization to which the maintenance worker belongs, for example, a company. In a case where this department is provided for each of a plurality of areas, the incentive target is a department for each of the plurality of areas.

In a case where the incentive is given to an organization, the skill management unit 160 statistically processes skills owned by a plurality of maintenance workers belonging to the organization. An example of this statistical processing is to calculate the number of owners for each of a plurality of skills. Then, in a case where the processing result satisfies the criterion, the skill management unit 160 performs processing for giving an incentive to the organization. An example of the criterion here is to exceed a reference number (for example, the number of people indicated by the demand information described above). This processing may be performed for each of a plurality of skills.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

While a plurality of steps (processes) is described in order in the plurality of flowcharts used in the descriptions above, the execution order of the steps executed in each example embodiment is not limited to the described order. In each example embodiment, the order of the illustrated steps can be changed as long as the modification does not substantively affect the process.

Some or all of the example embodiments described above may be described as the following Supplementary Notes, but are not limited to the following.

1. An information output device including: first acquisition means for acquiring supply information capable of specifying the number of maintenance workers who perform maintenance on a target device for each of a plurality of areas and for each of a plurality of skills owned by the maintenance workers; second acquisition means for acquiring demand information capable of specifying the required number of maintenance workers having the skill for each of the plurality of areas and for each of the plurality of skills; and output means for outputting supply and demand information based on the supply information and the demand information in a specifiable mode for each of the plurality of areas.

2. The information output device according to Supplementary Note 1, in which the output means outputs map information for displaying a map on a display, and outputs information for displaying the supply and demand information for each of the plurality of areas in association with a region associated with the area in the map on the display.

3. The information output device according to Supplementary Note 1 or 2, in which a plurality of the maintenance workers belongs to at least one of a first company and an associated company of the first company, there are a plurality of types of the target devices, the first target device is manufactured and/or sold by the first company, the second target device is manufactured by a second company different from both the first company and the associated company, and the plurality of skills includes a first skill set for the first target device and a second skill set for the second target device.

4. The information output device according to any one of Supplementary Note 1 to 3, in which

there are a plurality of types of the target devices, and the second acquisition means generates the demand information by using sales information for each of the plurality of types of target devices and each of the plurality of areas.

5. The information output device according to any one of Supplementary Notes 1 to 4, in which the second acquisition means generates the demand information by using performance information indicating performance of maintenance performed on the target device.

6. The information output device according to any one of Supplementary Notes 1 to 5, in which the output means includes guide means for generating, for each of the plurality of areas, recommended skill information indicating the skill to be acquired by the maintenance worker belonging to the area by using the supply information and the demand information.

7. The information output device according to Supplementary Note 6, in which the output means outputs support information capable of specifying a method for acquiring the skill indicated by the recommended skill information.

8. The information output device according to any one of Supplementary Notes 1 to 7, further including skill management means for causing storage means to store, for each of a plurality of the maintenance workers, owned skill information indicating a skill owned by the maintenance worker according to verifiable credentials.

9. An information output method causing a computer to perform: acquiring supply information capable of specifying the number of maintenance workers who perform maintenance on a target device for each of a plurality of areas and for each of a plurality of skills owned by the maintenance workers; acquiring demand information capable of specifying the required number of maintenance workers having the skill for each of the plurality of areas and for each of the plurality of skills; and outputting supply and demand information based on the supply information and the demand information in a specifiable mode for each of the plurality of areas.

10. A program causing a computer to execute: first acquisition means for acquiring supply information capable of specifying the number of maintenance workers who perform maintenance on a target device for each of a plurality of areas and for each of a plurality of skills owned by the maintenance workers; second acquisition means for acquiring demand information capable of specifying the required number of maintenance workers having the skill for each of the plurality of areas and for each of the plurality of skills; and output means for outputting supply and demand information based on the supply information and the demand information in a specifiable mode for each of the plurality of areas.

11. A recording medium in which the program according to Supplementary Note 10 is recorded.

Some or all of the configurations described in Supplementary Notes 2 to 8 dependent on the above-described Supplementary Note 1 can also be dependent on each of Supplementary Notes 9 to 11 by the same dependency relationship as in Supplementary Notes 2 to 8. Not only Supplementary Notes 1 and 9 to 11, but also various hardware, software, various recording means for recording software, or systems can be similarly dependent on some or all of the configurations described as the supplementary notes without departing from the above-described example embodiments.

1. An information output apparatus comprising:
first acquisition means for acquiring supply information capable of specifying the number of maintenance workers who perform maintenance on a target device for each of a plurality of areas and for each of a plurality of skills owned by the maintenance workers;
second acquisition means for acquiring demand information capable of specifying the required number of maintenance workers having the skill for each of the plurality of areas and for each of the plurality of skills; and
output means for outputting supply and demand information based on the supply information and the demand information in a specifiable mode for each of the plurality of areas.

2. The information output apparatus according to claim 1, wherein
the output means outputs map information for displaying a map on a display, and
outputs information for displaying the supply and demand information for each of the plurality of areas in association with a region associated with the area in the map on the display.

3. The information output apparatus according to claim 1, wherein
a plurality of the maintenance workers belongs to at least one of a first company and an associated company of the first company,
there are a plurality of types of the target devices,
the first target device is manufactured and/or sold by the first company,
the second target device is manufactured by a second company different from both the first company and the associated company, and
the plurality of skills comprises a first skill set for the first target device and a second skill set for the second target device.

4. The information output apparatus according to claim 1, wherein
there are a plurality of types of the target devices, and
the second acquisition means generates the demand information by using sales information for each of the plurality of types of target devices and each of the plurality of areas.

5. The information output apparatus according to claim 1, wherein
the second acquisition means generates the demand information by using performance information indicating performance of maintenance performed on the target device.

6. The information output apparatus according to claim 1, wherein
the output means comprises guide means for generating, for each of the plurality of areas, recommended skill information indicating the skill to be acquired by the maintenance worker belonging to the area by using the supply information and the demand information.

7. The information output apparatus according to claim 6, wherein
the output means outputs support information capable of specifying a method for acquiring the skill indicated by the recommended skill information.

8. The information output apparatus according to claim 1, further comprising
skill management means for causing storage means to store, for each of a plurality of the maintenance workers, owned skill information indicating a skill owned by the maintenance worker according to verifiable credentials.

9. An information output method causing a computer to perform:
acquiring supply information capable of specifying the number of maintenance workers who perform maintenance on a target device for each of a plurality of areas and for each of a plurality of skills owned by the maintenance workers;
acquiring demand information capable of specifying the required number of maintenance workers having the skill for each of the plurality of areas and for each of the plurality of skills; and
outputting supply and demand information based on the supply information and the demand information in a specifiable mode for each of the plurality of areas.

10. A non-transitory storage medium storing a program causing a computer to execute:
acquiring supply information capable of specifying the number of maintenance workers who perform maintenance on a target device for each of a plurality of areas and for each of a plurality of skills owned by the maintenance workers;
acquiring demand information capable of specifying the required number of maintenance workers having the skill for each of the plurality of areas and for each of the plurality of skills; and
outputting supply and demand information based on the supply information and the demand information in a specifiable mode for each of the plurality of areas.
